(19) United States
(12) Patent Application Publication
(10) Pub. No.: US 2024/0310710 A1
(43) Pub. Date: Sep. 19, 2024

(54) CONTROL DEVICE AND PROJECTION DISPLAY DEVICE

(71) Applicant: Panasonic Intellectual Property Management Co., Ltd., Osaka (JP)

(72) Inventors: Yusaku Nishikawa, Osaka (JP); Shigekazu Yamagishi, Osaka (JP)

(21) Appl. No.: 18/675,571

(22) Filed: May 28, 2024

Related U.S. Application Data
(63) Continuation of application No. PCT/JP2022/041735, filed on Nov. 9, 2022.

(30) Foreign Application Priority Data
Nov. 29, 2021 (JP) 2021-193186

(51) Int. Cl. G03B 21/20; G03B 21/16; G03B 33/08; H02P 29/60

(52) U.S. Cl. CPC G03B 21/206; G03B 21/16; G03B 33/08; H02P 29/60

(57) ABSTRACT

A control device according to the present disclosure is a control device for controlling a rotational speed of a phosphor wheel. The device includes an atmospheric pressure sensor that acquires atmospheric pressure information indicating an atmospheric pressure around the phosphor wheel, and a controller that controls the rotational speed of the phosphor wheel based on the atmospheric pressure information.

### BACKGROUND

### 1. Technical Field

The present disclosure relates to a control device and a projection display device.

### 2. Description of the Related Art

Patent Literature (PTL) 1 discloses a light source device used in a projector. The light source device described in PTL 1 includes a light source, a rotating body on which a layer of a phosphor that emits light in response to light emitted from the light source, a drive source that rotates the rotating body, rotational speed control means for variably controlling a rotational speed of the rotating body, and temperature measurement means for measuring a temperature of the rotating body. The rotational speed control means variably controls the rotational speed of the rotating body to maintain the temperature of the rotating body at a predetermined value based on temperature information from the temperature measurement means.

PTL 1 is Unexamined Japanese Patent Publication No. 2015-14666.

### SUMMARY

In recent years, there is a demand for appropriately controlling the rotational speed of the phosphor wheel.

An object of the present disclosure is to provide a control device and a projection display device capable of appropriately controlling a rotational speed of a phosphor wheel.

A control device according to one aspect of the present disclosure is a control device for controlling a rotational speed of a phosphor wheel. The device includes an atmospheric pressure sensor that acquires atmospheric pressure information indicating an atmospheric pressure around the phosphor wheel, and a controller that controls the rotational speed of the phosphor wheel based on the atmospheric pressure information.

A projection display device according to another aspect of the present disclosure includes the control device according to the above aspect.

The present disclosure can provide a control device and a projection display device capable of appropriately controlling a rotational speed of a phosphor wheel.

### BRIEF DESCRIPTION OF THE DRAWINGS

FIG. 1 is a block diagram illustrating an example of a schematic configuration of a control device according to a first exemplary embodiment.

FIG. 2 is a diagram illustrating an example of a schematic configuration of a phosphor wheel.

FIG. 3 is a flowchart of an example of a control method according to the first exemplary embodiment.

FIG. 4 is a diagram illustrating an example of a first table.

FIG. 5 is a diagram illustrating a settable range of a rotational speed of the phosphor wheel according to the first exemplary embodiment.

FIG. 6 is a flowchart of an example of rotational speed control according to the first exemplary embodiment.

FIG. 7 is a block diagram illustrating an example of a schematic configuration of a projection display device.

FIG. 8 is a block diagram illustrating an example of a schematic configuration of a control device according to a second exemplary embodiment.

FIG. 9 is a flowchart of an example of a control method according to the second exemplary embodiment.

FIG. 10 is a diagram illustrating an example of a second table.

FIG. 11 is a diagram illustrating a settable range of a rotational speed of a phosphor wheel according to the second exemplary embodiment.

FIG. 12 is a flowchart of an example of rotational speed control according to the second exemplary embodiment.

### DETAILED DESCRIPTION

Hereinafter, exemplary embodiments will be described in detail with reference to the drawings as appropriate. However, descriptions more in detail than necessary may be omitted. For example, the detailed description of already well-known matters and the redundant description of substantially identical configurations may be omitted. This is to avoid unnecessary redundancy of the following description and to facilitate understanding of those skilled in the art.

Note that, the accompanying drawings and the following descriptions are provided to facilitate those skilled in the art to sufficiently understand the present disclosure, and are not intended to limit the subject matter described in the claims.

### First Exemplary Embodiment

### 1-1. Configuration of Control Device

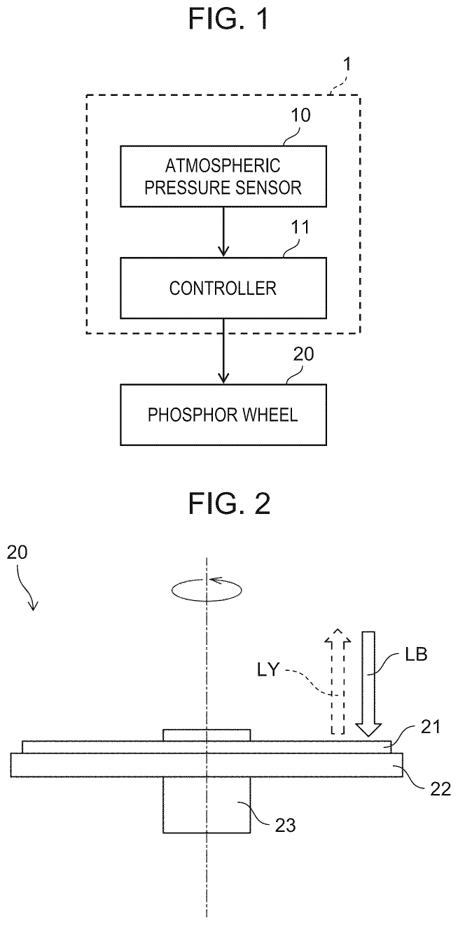

FIG. 1 is a block diagram illustrating a schematic configuration of control device 1 according to a first exemplary embodiment. As illustrated in FIG. 1, control device 1 includes atmospheric pressure sensor 10 and controller 11. Control device 1 controls a rotational speed of phosphor wheel 20. Control device 1 is used, for example, in a projection display device such as a projector that displays a video.

Atmospheric pressure sensor 10 acquires atmospheric pressure information related to an atmospheric pressure around a location where phosphor wheel 20 is disposed (atmospheric pressure information indicating an atmospheric pressure around phosphor wheel 20). Specifically, atmospheric pressure sensor 10 acquires information on an outside atmospheric pressure. For example, the outside atmospheric pressure means an atmospheric pressure outside a housing in which phosphor wheel 20 is housed.

For example, the atmospheric pressure sensor includes a piezoresistive sensor or a capacitive sensor using a semiconductor. For example, the piezoresistive sensor detects a change in electric resistance due to a piezoresistive effect generated by deformation of a diaphragm by an outside pressure, and calculates an atmospheric pressure from the change in the electric resistance. For example, the capacitive sensor detects a change in capacitance generated by the deformation of the diaphragm by the outside pressure, and calculates the atmospheric pressure from the change in the capacitance.

The atmospheric pressure information acquired by atmospheric pressure sensor 10 is sent to controller 11.

Controller 11 controls the rotational speed of phosphor wheel 20 based on the atmospheric pressure information. Controller 11 can be implemented by a semiconductor device or the like. Controller 11 may be, for example, a microcomputer, a central processing unit (CPU), a microprocessor unit (MPU), a graphics processor unit (GPU), a digital signal processor (DSP), a field-programmable gate array (FPGA), or an application specific integrated circuit (ASIC). Functions of controller 11 may be implemented only by hardware, or may be implemented by a combination of the hardware and software. Controller 11 implements a predetermined function by reading out data and a program stored in a storage such as a memory and performing various types of arithmetic processing.

FIG. 2 is a diagram illustrating an example of a schematic configuration of phosphor wheel 20. As illustrated in FIG. 2, phosphor wheel 20 includes phosphor 21, wheel body 22, and motor 23.

For example, phosphor 21 receives light from a light source and emits light. For example, phosphor 21 is a YAG phosphor that is excited by blue light LB and emits yellow light LY containing green and red wavelength components.

Wheel body 22 is a plate-shaped member having a first surface and a second surface opposite to the first surface. Phosphor 21 is applied to the first surface of wheel body 22. For example, wheel body 22 has a disk shape. Wheel body 22 is rotatably held. Wheel body 22 is formed of, for example, a circular aluminum substrate. A fin (not illustrated) is provided on the second surface of wheel body 22. Phosphor wheel 20 has the fin on the second surface of wheel body 22, and thus, it is possible to efficiently cool phosphor wheel 20 itself when the rotational speed of phosphor wheel 20 is controlled as will be described later.

Motor 23 rotates wheel body 22. Motor 23 is disposed at a center of wheel body 22. Motor 23 is controlled by controller 11.

### 1-2. Operation of Control Device

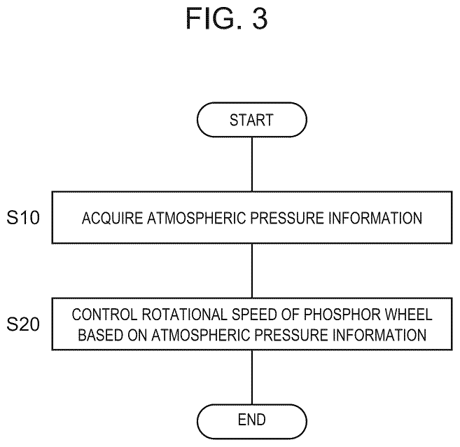

Hereinafter, an operation of control device 1 having the above-described configuration will be described with reference to FIG. 3. FIG. 3 is a flowchart illustrating an example of a control method according to the first exemplary embodiment.

As illustrated in FIG. 3, in step S10, atmospheric pressure sensor 10 acquires the atmospheric pressure information. Specifically, atmospheric pressure sensor 10 acquires the atmospheric pressure information related to the atmospheric pressure around the location where phosphor wheel 20 is disposed. For example, atmospheric pressure sensor 10 acquires the information on the outside atmospheric pressure.

Atmospheric pressure sensor 10 transmits the acquired atmospheric pressure information to controller 11.

In step S20, controller 11 controls the rotational speed of phosphor wheel 20 based on the atmospheric pressure information. Specifically, controller 11 determines a settable range of the rotational speed of phosphor wheel 20 in accordance with the atmospheric pressure.

In the present exemplary embodiment, controller 11 determines the settable range of the rotational speed of phosphor wheel 20 by using a first table indicating a relationship among a plurality of atmospheric pressure conditions, temperatures of phosphor wheel 20, and rotational speeds of phosphor wheel 20.

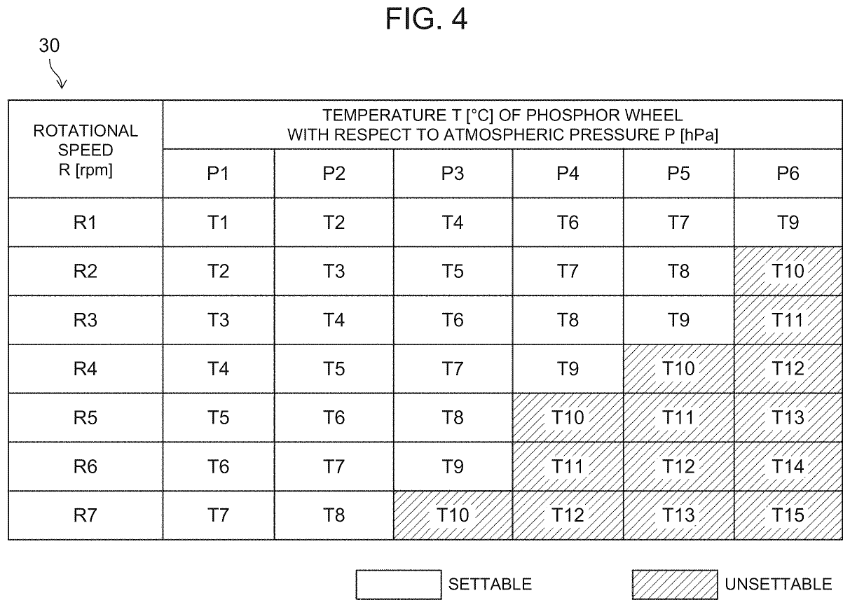

FIG. 4 is a diagram of an example of first table 30. As illustrated in FIG. 4, first table 30 shows a relationship among a plurality of atmospheric pressure conditions P1 to P6, rotational speeds R1 to R7 of phosphor wheel 20, and temperatures T1 to T15 of phosphor wheel 20.

In FIG. 4, the plurality of atmospheric pressure conditions P1 to P6 decrease from atmospheric pressure condition P1 to atmospheric pressure condition P6. That is, under the plurality of atmospheric pressure conditions, atmospheric pressure condition P1 is the largest, and atmospheric pressure condition P6 is the smallest.

Rotational speeds R1 to R7 of phosphor wheel 20 indicate rotational speeds changeable under the plurality of atmospheric pressure conditions P1 to P6. Rotational speeds R1 to R7 of phosphor wheel 20 decrease from rotational speed R1 to rotational speed R7. That is, rotational speed R1 is the highest, and rotational speed R7 is the lowest.

Temperatures T1 to T15 of phosphor wheel 20 indicate temperatures of phosphor 21 when the rotational speed of phosphor wheel 20 is changed under the plurality of atmospheric pressure conditions P1 to P6. Temperatures T1 to T15 of phosphor wheel 20 shown in first table 30 are temperatures measured in advance under the plurality of atmospheric pressure conditions P1 to P6. Temperatures T1 to T15 increase from temperature T1 to temperature T15. That is, temperature T1 is the lowest, and temperature T 15 is the highest.

First table 30 shows a relationship in which temperature T of phosphor wheel 20 increases as atmospheric pressure P decreases and temperature T of phosphor wheel 20 increases as rotational speed R decreases. That is, first table 30 shows a relationship in which temperature T of phosphor wheel 20 increases as atmospheric pressure P indicated by each of the plurality of atmospheric pressure conditions P1 to P6 decreases and a relationship in which temperature T of phosphor wheel 20 increases as rotational speed R of phosphor wheel 20 decreases.

First table 30 determines the settable range of the rotational speed of phosphor wheel 20 under each of the plurality of atmospheric pressure conditions P1 to P6 by using first threshold temperature TL1 of the temperature of phosphor wheel 20. First threshold temperature TL1 is determined based on, for example, a temperature at which phosphor 21 is not melted. For example, first threshold temperature TL1 is set to a temperature lower than a temperature upper limit of a material constituting phosphor wheel 20. Note that, first threshold temperature TL1 may be changed in accordance with a type of phosphor 21.

In the present exemplary embodiment, first threshold temperature TL1 is set to temperature T9. As illustrated in FIG. 4, in the plurality of atmospheric pressure conditions P1 to P6, rotational speeds R of phosphor wheel 20 corresponding to temperatures T10 to T15 exceeding temperature T9 is unsettable. On the other hand, rotational speeds R of phosphor wheel 20 corresponding to temperatures T1 to T9 less than or equal to temperature T9 can be set.

As described above, in first table 30, a lower limit value of the settable range of the rotational speed of phosphor wheel 20 is determined based on first threshold temperature TL1 of phosphor wheel 20.

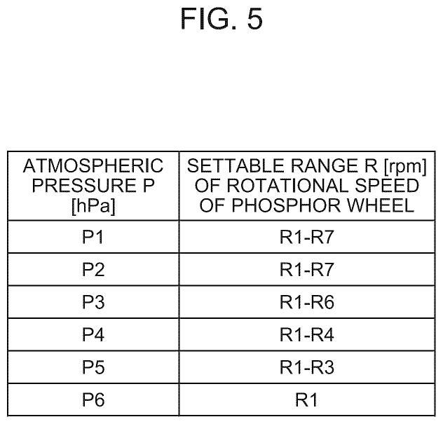

FIG. 5 is a diagram illustrating the settable range of rotational speed R of phosphor wheel 20 according to the first exemplary embodiment. As illustrated in FIG. 5, for example, in the case of atmospheric pressure conditions P1 and P2, rotational speeds R can be set in a range of rotational speeds R1 to R7, and in the case of atmospheric pressure condition P4, rotational speeds R can be set in a range of rotational speeds R1 to R4.

As described above, as the atmospheric pressure decreases, the lower limit value of rotational speed R in the settable range increases. For example, as illustrated in FIGS. 4 and 5, the lower limit values of rotational speeds R under atmospheric pressure conditions P1 to P6 are set to rotational speeds R7, R7, R6, R4, R3, and R1, respectively.

Based on first table 30, controller 11 increases the lower limit values of rotational speeds R of phosphor wheel 20 in the settable range as the atmospheric pressure decreases.

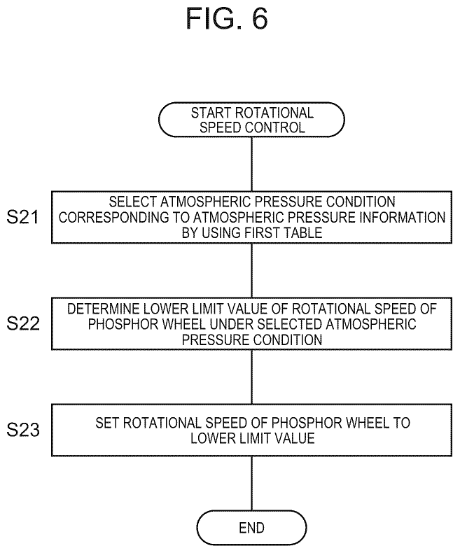

FIG. 6 is a flowchart illustrating an example of rotational speed control according to the first exemplary embodiment. FIG. 6 illustrates an example of detailed control of step S20 illustrated in FIG. 5.

As illustrated in FIG. 6, in step S21, controller 11 selects the atmospheric pressure condition corresponding to the atmospheric pressure information by using first table 30. Specifically, controller 11 selects the atmospheric pressure condition corresponding to the atmospheric pressure acquired by atmospheric pressure sensor 10 from among the plurality of atmospheric pressure conditions P1 to P6 of first table 30. For example, controller 11 selects an atmospheric pressure condition having a smallest difference between the atmospheric pressure acquired by atmospheric pressure sensor 10 and the atmospheric pressures of the atmospheric pressure conditions P1 to P6.

In step S22, controller 11 determines the lower limit value of rotational speed R of phosphor wheel 20 under the selected atmospheric pressure condition by using first table 30. In each of the plurality of atmospheric pressure conditions P1 to P6, the lower limit value of rotational speed R of phosphor wheel 20 determined by first threshold temperature TL1 is set. For example, the lower limit value of rotational speed R of phosphor wheel 20 is rotational speed R6 under atmospheric pressure condition P3, and the lower limit value of rotational speed R of phosphor wheel 20 is rotational speed R3 under atmospheric pressure condition P5. That is, in a case where atmospheric pressure condition P5 is selected, controller 11 determines, as the lower limit value, lowest rotational speed R3 among the rotational speeds (rotational speeds R1 to R3) corresponding to the temperatures (temperatures T7 to T9) less than or equal to first threshold temperature TL1 under atmospheric pressure condition P5.

As described above, controller 11 determines, as the lower limit value, a lowest rotational speed among rotational speeds R1 to R7 at which the temperature of phosphor wheel 20 is less than or equal to first threshold temperature TL1 under the selected atmospheric pressure condition. Accordingly, controller 11 determines the settable range of the rotational speed of phosphor wheel 20.

In step S23, controller 11 sets rotational speed R of phosphor wheel 20 to the lower limit value. For example, under atmospheric pressure condition P3, since the settable range of rotational speed R of phosphor wheel 20 is rotational speeds R1 to R6, controller 11 sets rotational speed R of phosphor wheel 20 to rotational speed R6 under atmospheric pressure condition P3. Alternatively, under atmospheric pressure condition P5, since the settable range of rotational speed R of phosphor wheel 20 is rotational speeds R1 to R3, controller 11 sets rotational speed R of phosphor wheel 20 to rotational speed R3 under atmospheric pressure condition P5.

As described above, in the present exemplary embodiment, controller 11 determines the lower limit value of rotational speed R of phosphor wheel 20 in accordance with the atmospheric pressure, and sets rotational speed R of phosphor wheel 20 to the lower limit value.

1-3. Configuration of projection display device

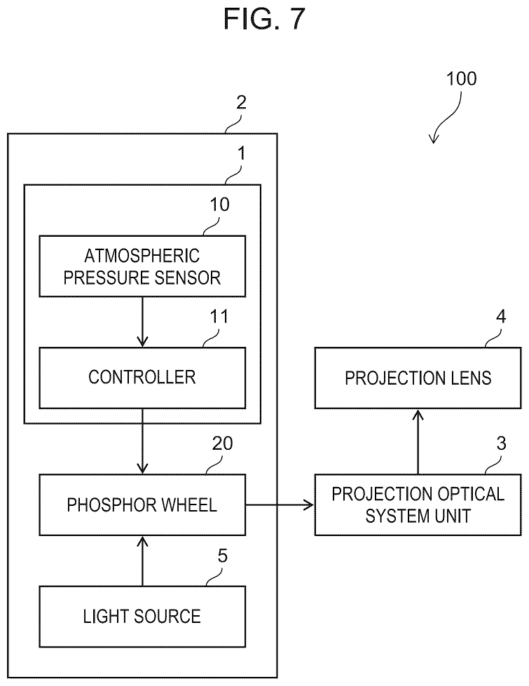

FIG. 7 is a block diagram illustrating an example of a schematic configuration of projection display device 100.

As illustrated in FIG. 7, projection display device 100 includes light source unit 2, projection optical system unit 3, and projection lens 4. Light source unit 2 includes control device 1, phosphor wheel 20, and light source 5.

For example, light source unit 2 generates white light from light emitted from light source 5 by phosphor wheel 20 or the like, and emits the white light to projection optical system unit 3.

For example, projection optical system unit 3 receives the light emitted from light source unit 2, and projects projection light through projection lens 4.

Projection lens 4 is a lens that is attached to projection optical system unit 3 and projects the projection light.

As described above, projection display device 100 includes control device 1 described above, and controls the rotational speed of phosphor wheel 20.

### 1-4. Effects and the Like

Control device 1 according to the present disclosure is a control device for controlling the rotational speed of phosphor wheel 20, and control device 1 includes atmospheric pressure sensor 10 that acquires the atmospheric pressure information related to the atmospheric pressure around the location where phosphor wheel 20 is disposed, and controller 11 that controls the rotational speed of phosphor wheel 20 based on the atmospheric pressure information. With such a configuration, the rotational speed of phosphor wheel 20 can be appropriately controlled in accordance with the atmospheric pressure.

For example, when the atmospheric pressure decreases, since a wind speed around phosphor wheel 20 decreases, cooling efficiency of phosphor wheel 20 may decrease. According to control device 1, since the rotational speed of phosphor wheel 20 is controlled in accordance with the atmospheric pressure, it is possible to suppress a decrease in the cooling efficiency of phosphor wheel 20 due to the influence of the atmospheric pressure. Accordingly, reliability of phosphor wheel 20 can be improved.

In addition, the rotational speed of phosphor wheel 20 is controlled in accordance with the atmospheric pressure, noise due to the rotation of phosphor wheel 20 can be reduced. For example, in a case where the temperature of phosphor wheel 20 is relatively low, noise can be reduced by reducing the rotational speed of phosphor wheel 20.

Controller 11 determines the settable range of the rotational speed of phosphor wheel 20 in accordance with the atmospheric pressure. With such a configuration, the rotational speed of phosphor wheel 20 can be more appropriately controlled.

As the atmospheric pressure decreases, controller 11 increases the lower limit value of the rotational speed of phosphor wheel 20 in the settable range. With such a configuration, it is possible to further suppress the decrease in the cooling efficiency of phosphor wheel 20.

Controller 11 determines the lower limit value based on first table 30 indicating the relationship among the plurality of atmospheric pressure conditions P1 to P6, rotational speeds R1 to R7 of phosphor wheel 20, and temperatures T1 to T15 of phosphor wheel 20, first threshold temperature TL1 of the temperature of phosphor wheel 20, and the atmospheric pressure information. With such a configuration, controller 11 can more easily control the rotational speed of phosphor wheel 20 in accordance with the atmospheric pressure by using first table 30. Further, controller 11 can more appropriately control the rotational speed of phosphor wheel 20 in accordance with the atmospheric pressure while suppressing the decrease in the cooling efficiency of phosphor wheel 20.

First table 30 shows the relationship in which the temperature of phosphor wheel 20 increases as the atmospheric pressure decreases and the temperature of phosphor wheel 20 increases as the rotational speed decreases. Controller 11 selects the atmospheric pressure condition corresponding to the atmospheric pressure information from among the plurality of atmospheric pressure conditions P1 to P6 by using first table 30, and determines, as the lower limit value, lowest rotational speed among the rotational speeds at which the temperature of phosphor wheel 20 is less than or equal to first threshold temperature TL1 under the selected atmospheric pressure condition. With such a configuration, noise due to the rotation of phosphor wheel 20 can be reduced while cooling performance of phosphor wheel 20 is maintained.

Controller 11 sets the rotational speed of phosphor wheel 20 to the lower limit value. With such a configuration, noise due to the rotation of phosphor wheel 20 can be further reduced while cooling performance of phosphor wheel 20 is maintained.

Projection display device 100 according to the present disclosure includes control device 1 of the above-described aspect. With such a configuration, it is possible to achieve effects similar to the effects of control device 1 described above.

### Second Exemplary Embodiment

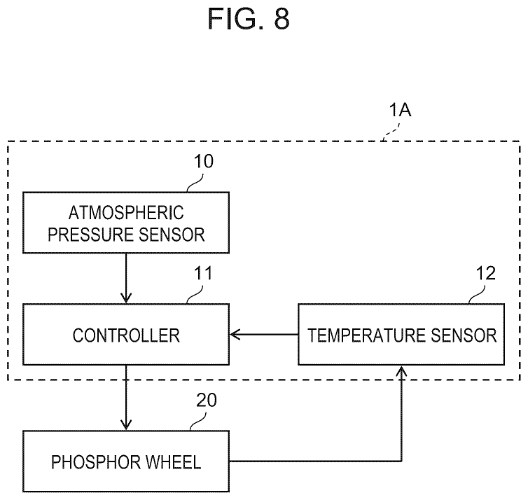

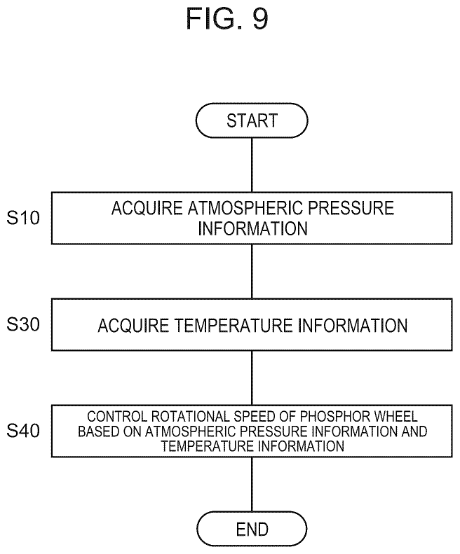

Hereinafter, a second exemplary embodiment will be described with reference to FIGS. 8 and 9. FIG. 8 is a block diagram illustrating an example of a schematic configuration of a control device according to the second exemplary embodiment, and FIG. 9 is a flowchart of an example of the control method according to the second exemplary embodiment.

The second exemplary embodiment will be described mainly on points different from the first exemplary embodiment. In the second exemplary embodiment, a configuration identical or equivalent to the configuration of the first exemplary embodiment will be denoted by the same reference mark. In addition, the description already given for the first exemplary embodiment will be omitted for the second exemplary embodiment.

The second exemplary embodiment is different from the first exemplary embodiment in that control device 1A includes temperature sensor 12 and controls a rotational speed of phosphor wheel 20 based on atmospheric pressure information and temperature information.

### 2-1. Configuration

As illustrated in FIG. 8, control device 1A includes atmospheric pressure sensor 10, controller 11, and temperature sensor 12. Since configurations of atmospheric pressure sensor 10 and controller 11 are similar to the configurations of the first exemplary embodiment, the description thereof will be omitted.

Temperature sensor 12 acquires temperature information related to a temperature of phosphor wheel 20. Specifically, temperature sensor 12 measures a temperature of phosphor 21. For example, temperature sensor 12 is a non-contact temperature sensor that acquires a temperature without touching phosphor wheel 20. The non-contact temperature sensor may be, for example, an infrared thermometer that measures the amount of infrared energy.

Temperature information acquired by temperature sensor 12 is sent to controller 11.

Controller 11 controls the rotational speed of phosphor wheel 20 based on atmospheric pressure information acquired by atmospheric pressure sensor 10 and the temperature information acquired by temperature sensor 12.

### 2-2. Operation

An operation of control device 1A having the above-described configuration will be described with reference to FIG. 9.

As illustrated in FIG. 9, in step S10, atmospheric pressure sensor 10 acquires the atmospheric pressure information. Atmospheric pressure sensor 10 transmits the acquired atmospheric pressure information to controller 11.

In step S30, temperature sensor 12 acquires the temperature information. Specifically, temperature sensor 12 acquires the temperature of phosphor 21 of phosphor wheel 20.

Temperature sensor 12 transmits the acquired temperature information to controller 11.

In step S40, controller 11 controls the rotational speed of phosphor wheel 20 based on the atmospheric pressure information and the temperature information. Specifically, controller 11 determines a settable range of the rotational speed of phosphor wheel 20 in accordance with the atmospheric pressure and the temperature of phosphor wheel 20.

In the present exemplary embodiment, controller 11 determines the settable range of the rotational speed of phosphor wheel 20 by using second table indicating a relationship among a plurality of atmospheric pressure conditions, rotational speeds of phosphor wheel 20, and motor temperatures of motor 23 in addition to first table 30.

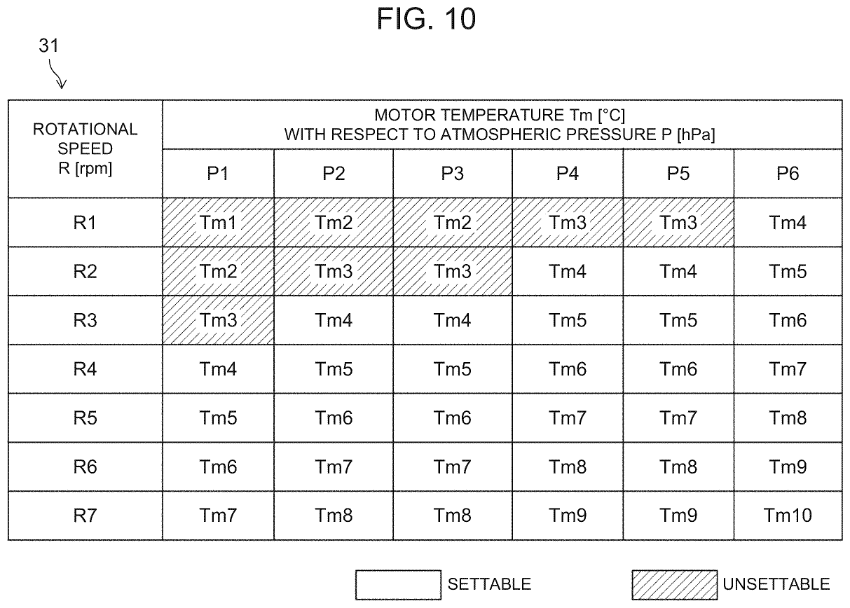

FIG. 10 is a diagram illustrating an example of second table 31. As illustrated in FIG. 10, second table 31 shows a relationship among a plurality of atmospheric pressure conditions P1 to P6, rotational speeds R1 to R7 of phosphor wheel 20, and motor temperatures Tm1 to Tm10 of motor 23.

In FIG. 10, motor temperatures Tm1 to Tm10 of motor 23 indicate temperatures of motor 23 in a case where the rotational speed of phosphor wheel 20 is changed under the plurality of atmospheric pressure conditions P1 to P6. Motor temperatures Tm1 to Tm10 shown in second table 31 are temperatures measured in advance under the plurality of atmospheric pressure conditions P1 to P6. Motor temperatures Tm1 to Tm10 of motor 23 decrease from motor temperature Tm1 to motor temperature Tm10. That is, motor temperature Tm1 is the highest, and motor temperature Tm10 is the lowest.

Note that, the plurality of atmospheric pressure conditions P1 to P6 and rotational speeds R1 to R7 of phosphor wheel 20 are similar to the atmospheric pressure conditions and rotational speeds in the first exemplary embodiment.

Second table 31 shows a relationship in which motor temperature Tm decreases as atmospheric pressure P decreases and motor temperature Tm decreases as rotational speed R decreases. That is, second table 31 shows a relationship in which motor temperature Tm decreases as atmospheric pressure P indicated by each of the plurality of atmospheric pressure conditions increases and a relationship in which motor temperature Tm increases as rotational speed R of motor 23 increases.

Second table 31 determines the settable range of the rotational speed of phosphor wheel 20 under each of the plurality of atmospheric pressure conditions P1 to P6 by using second threshold temperature TL2 of motor temperature Tm. Second threshold temperature TL2 is, for example, an upper limit temperature at which motor 23 normally operates. Note that, second threshold temperature TL2 may be changed in accordance with a type and a specification of motor 23.

In the present exemplary embodiment, second threshold temperature TL2 is set to motor temperature Tm4. As illustrated in FIG. 10, in the plurality of atmospheric pressure conditions P1 to P6, rotational speeds R of phosphor wheel 20 corresponding to motor temperatures Tm1 to Tm3 exceeding motor temperature Tm4 is unsettable. On the other hand, rotational speeds R of phosphor wheel 20 corresponding to motor temperatures Tm4 to Tm10 less than or equal to motor temperature Tm4 can be set.

As described above, in second table 31, an upper limit value of the settable range of the rotational speed of phosphor wheel 20 is determined based on second threshold temperature TL2 of motor 23.

In addition, as in the first exemplary embodiment, in the present exemplary embodiment, a lower limit value of the settable range of the rotational speed of phosphor wheel 20 is determined based on first threshold temperature TL1 of phosphor wheel 20 by using first table 30.

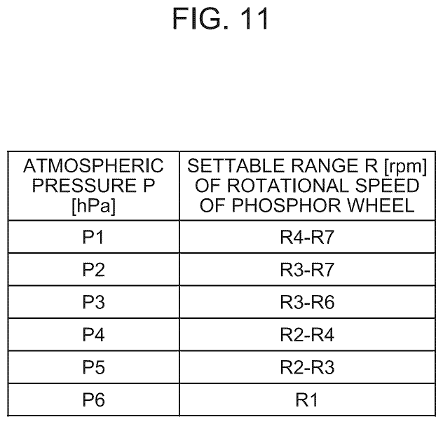

FIG. 11 is a diagram illustrating the settable range of rotational speed R of phosphor wheel 20 according to the second exemplary embodiment. As illustrated in FIG. 11, for example, in the case of atmospheric pressure condition P1, rotational speeds R can be set in a range of rotational speeds R4 to R7, and in the case of atmospheric pressure condition P4, rotational speeds R can be set in a range of rotational speeds R2 to R4.

As described above, as the atmospheric pressure decreases, the upper limit value and the lower limit value of rotational speed R in the settable range increase. For example, as illustrated in FIG. 11, the upper limit values of rotational speeds R under the atmospheric pressure conditions P1 to P6 are set to rotational speeds R4, R3, R3, R2, R2, and R1, respectively. The lower limit values of rotational speeds R under atmospheric pressure conditions P1 to P6 are set to rotational speeds R7, R7, R6, R4, R3, and R1, respectively. Based on second table 31, controller 11 increases the upper limit value of rotational speed R of phosphor wheel 20 in the settable range as the atmospheric pressure decreases. In addition, based on first table 30, controller 11 increases the lower limit value of rotational speed R of phosphor wheel 20 in the settable range as the atmospheric pressure decreases.

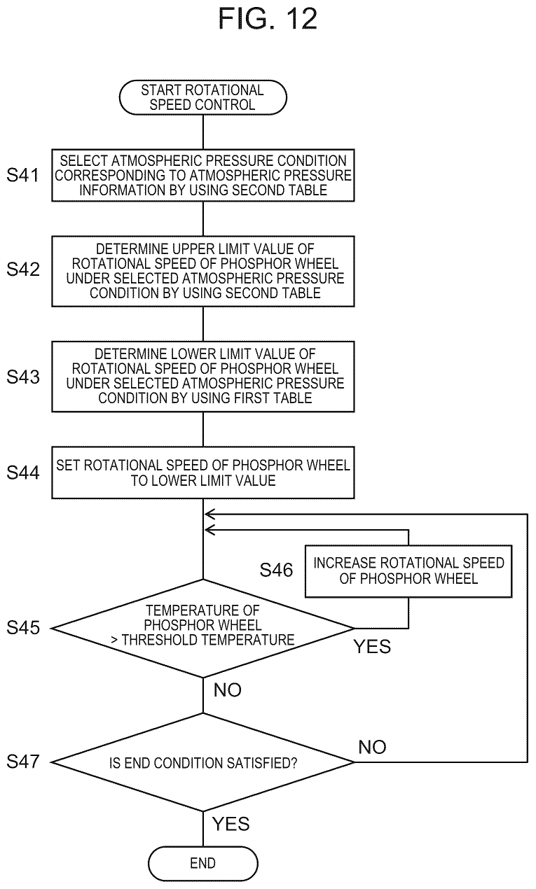

FIG. 12 is a flowchart illustrating an example of rotational speed control according to the second exemplary embodiment. FIG. 12 illustrates an example of detailed control of step S40 illustrated in FIG. 9.

As illustrated in FIG. 12, in step S41, controller 11 selects the atmospheric pressure condition corresponding to the atmospheric pressure information by using the second table. Specifically, controller 11 selects the atmospheric pressure condition corresponding to the atmospheric pressure acquired by atmospheric pressure sensor 10 from among the plurality of atmospheric pressure conditions P1 to P6 of second table 31. For example, controller 11 selects an atmospheric pressure condition having a smallest difference between the atmospheric pressure acquired by atmospheric pressure sensor 10 and the atmospheric pressures of the atmospheric pressure conditions P1 to P6.

In step S42, controller 11 determines the upper limit value of rotational speed R of phosphor wheel 20 under the selected atmospheric pressure condition by using second table 31. In each of the plurality of atmospheric pressure conditions P1 to P6, the upper limit value of rotational speed R of phosphor wheel 20 determined by second threshold temperature TL2 of motor temperature Tm is set. For example, the upper limit value of rotational speed R of phosphor wheel 20 is rotational speed R3 under atmospheric pressure condition P3, and the upper limit value of rotational speed R of phosphor wheel 20 is rotational speed R2 under atmospheric pressure condition P5. That is, in a case where atmospheric pressure condition P5 is selected, controller 11 determines, as the upper limit value, highest rotational speed R2 among the rotational speeds (rotational speeds R2 to R7) corresponding to the motor temperatures (motor temperatures Tm4 to Tm9) less than or equal to second threshold temperature TL2 under atmospheric pressure condition P5.

As described above, controller 11 determines, as the upper limit value, a highest rotational speed among rotational speeds R1 to R7 at which motor temperature Tm of motor 23 is less than or equal to second threshold temperature TL2 under the selected atmospheric pressure condition.

In step S43, controller 11 determines the lower limit value of rotational speed R of phosphor wheel 20 under the selected atmospheric pressure condition by using first table 30. In each of the plurality of atmospheric pressure conditions P1 to P6, the lower limit value of rotational speed R of phosphor wheel 20 determined by first threshold temperature TL1 of phosphor wheel 20 is set. For example, the lower limit value of rotational speed R of phosphor wheel 20 is rotational speed R6 under atmospheric pressure condition P3, and the lower limit value of rotational speed R of phosphor wheel 20 is rotational speed R3 under atmospheric pressure condition P5.

As described above, controller 11 determines, as the upper limit value, a highest rotational speed among rotational speeds R1 to R7 at which motor temperature Tm of motor 23 is less than or equal to second threshold temperature TL2 under the selected atmospheric pressure condition. In addition, controller 11 determines, as the lower limit value, a lowest rotational speed among rotational speeds R1 to R7 at which temperature T of phosphor wheel 20 is less than or equal to first threshold temperature TL1 under the selected atmospheric pressure condition. Accordingly, controller 11 determines the settable range of the rotational speed of phosphor wheel 20.

In step S44, controller 11 sets rotational speed R of phosphor wheel 20 to the lower limit value. For example, in atmospheric pressure condition P3, since the settable range of rotational speed R of phosphor wheel 20 is rotational speeds R3 to R6, controller 11 sets rotational speed R of phosphor wheel 20 to rotational speed R6 under atmospheric pressure condition P3. Alternatively, under atmospheric pressure condition P5, since the settable range of rotational speed R of phosphor wheel 20 is rotational speeds R2 to R3, controller 11 sets rotational speed R of phosphor wheel 20 to rotational speed R3 in atmospheric pressure condition P5.

In step S45, controller 11 determines whether or not the temperature of phosphor wheel 20 is more than third threshold temperature TL3. In a case where controller 11 determines that the temperature of phosphor wheel 20 is more than third threshold temperature TL3, the processing proceeds to step S46. In a case where controller 11 determines that the temperature of phosphor wheel 20 is less than or equal to third threshold temperature TL3, the processing proceeds to step S47.

Third threshold temperature TL3 may be, for example, the same as first threshold temperature TL1.

In step S46, controller 11 increases rotational speed R of phosphor wheel 20. For example, in a case where rotational speed R of phosphor wheel 20 is set to rotational speed R6 under atmospheric pressure condition P3, controller 11 sets rotational speed R of phosphor wheel 20 to rotational speed R5. That is, controller 11 increases rotational speed R of phosphor wheel 20 by one step. That is, controller 11 increases rotational speed R of phosphor wheel 20 from rotational speed R6 to rotational speed R5 based on first table 30. Specifically, controller 11 sets rotational speed R of phosphor wheel 20 to rotational speed R5 corresponding to temperature T8 more than first threshold temperature TL1 (temperature T9) under atmospheric pressure condition P3 of first table 30.

In step S47, controller 11 determines whether or not an end condition is satisfied. In a case where controller 11 determines that the end condition is satisfied, the processing ends. In a case where controller 11 determines that the end condition is not satisfied, the processing returns to step S45.

The end condition is a condition in which the rotational speed control by controller 11 is ended. For example, the end condition may be when control device 1A is powered off. Alternatively, the end condition may be when a rotational speed control function is turned off.

### 2-3. Effects and the Like

Control device 1A according to the present disclosure further includes temperature sensor 12 that acquires the temperature information related to the temperature of phosphor wheel 20. Controller 11 controls the rotational speed of phosphor wheel 20 based on the temperature information. With such a configuration, the rotational speed of phosphor wheel 20 can be more appropriately controlled in accordance with the atmospheric pressure and the temperature of phosphor wheel 20.

For example, in a case where the temperature of phosphor wheel 20 increases, the cooling efficiency of phosphor wheel 20 can be improved by increasing the rotational speed of phosphor wheel 20.

Phosphor wheel 20 includes phosphor 21, wheel body 22 to which phosphor 21 is applied, and motor 23 that rotates wheel body 22. Controller 11 determines the upper limit value of the rotational speed of phosphor wheel 20 based on second table 31 indicating the relationship among the plurality of atmospheric pressure conditions P1 to P6, rotational speeds R1 to R7 of phosphor wheel 20, and motor temperatures Tm1 to Tm10 of motor 23, and second threshold temperature TL2 of the motor temperature. With such a configuration, the upper limit value of the rotational speed of phosphor wheel 20 can be determined based on motor temperature Tm of motor 23. Accordingly, the rotational speed of phosphor wheel 20 can be appropriately controlled, and the reliability of phosphor wheel 20 can be improved.

Second table 31 shows a relationship in which motor temperature Tm decreases as the atmospheric pressure increases and motor temperature Tm increases as rotational speed R of phosphor wheel 20 increases. In second table 31, controller 11 selects the atmospheric pressure condition corresponding to the atmospheric pressure information from among the plurality of atmospheric pressure conditions P1 to P6, and determines, as the upper limit value, the highest rotational speed among rotational speeds R1 to R7 at which motor temperature Tm is less than or equal to second threshold temperature TL2 under the selected atmospheric pressure condition. With such a configuration, the rotational speed of phosphor wheel 20 can be more appropriately controlled, and the reliability of phosphor wheel 20 can be further improved.

When the temperature of phosphor wheel 20 is more than third threshold temperature TL3, controller 11 increases the rotational speed of phosphor wheel 20. With such a configuration, the cooling efficiency of phosphor wheel 20 can be improved in accordance with the temperature of phosphor wheel 20.

Temperature sensor 12 is a non-contact temperature sensor that acquires the temperature of phosphor wheel 20 without touching phosphor wheel 20. With such a configuration, the temperature of phosphor wheel 20 can be easily acquired.

Note that, in the above exemplary embodiment, although the control using first table 30 and the control using first table 30 and second table 31 have been described, the present disclosure is not limited thereto. Controller 11 may control the rotational speed of phosphor wheel 20 by using second table 31 without using first table 30. Alternatively, controller 11 may control the rotational speed of phosphor wheel 20 in accordance with the atmospheric pressure without using first table 30 and second table 31.

In the above exemplary embodiment, although the example in which the lower limit value of the rotational speed of phosphor wheel 20 is set and the example in which the upper limit value and the lower limit value of the rotational speed of phosphor wheel 20 are set have been described, the present disclosure is not limited thereto. For example, the upper limit value may be set without setting the lower limit value of the rotational speed of phosphor wheel 20.

In the above exemplary embodiment, although the example in which controller 11 sets the rotational speed of phosphor wheel 20 to the lower limit value of the settable range has been described, the present disclosure is not limited thereto. For example, controller 11 may determine the rotational speed of phosphor wheel 20 within the settable range. For example, under atmospheric pressure condition P3, controller 11 may set the rotational speed of phosphor wheel 20 to rotational speed R5 more than rotational speed R6 that is the lower limit value.

In the above exemplary embodiment, although it has been described that six atmospheric pressure conditions P1 to P6 and seven rotational speeds R1 to R7 are set on first table 30 and second table 31, the present disclosure is not limited thereto. The set numbers of the atmospheric pressure conditions and the rotational speeds may be any numbers.

In the above exemplary embodiment, although the example in which third threshold temperature TL3 is the same as first threshold temperature TL1 has been described, the present disclosure is not limited thereto. For example, third threshold temperature TL3 may be different from first threshold temperature TL1.

In the above exemplary embodiment, although the example in which projection display device 100 includes light source unit 2, projection optical system unit 3, and projection lens 4 has been described, the present disclosure is not limited thereto. projection display device 100 may include elements other than these elements.

As described above, the exemplary embodiments have been described as examples of the techniques in the present disclosure. Therefore, the accompanying drawings and the detailed descriptions have been presented. Thus, in order to exemplify the techniques described above, components illustrated or described in the accompanying drawings and the detailed descriptions may not only include components that are essential for solving the problems, but may also include components that are not essential for solving the problems. Thus, it should not be immediately construed that those non-essential components are essential only based on a fact that those non-essential components are illustrated or described in the accompanying drawings or the detailed descriptions.

In addition, since the above exemplary embodiments are for illustrating the techniques in the present disclosure, various modifications, substitutions, additions, omissions, and the like can be made without departing from the scope of the accompanying claims or an equivalent scope thereof.

### Overview of Exemplary Embodiments

(1) A control device according to the present disclosure is a control device for controlling a rotational speed of a phosphor wheel. The device includes an atmospheric pressure sensor that acquires atmospheric pressure information related to an atmospheric pressure around a location where the phosphor wheel is disposed, and a controller that controls the rotational speed of the phosphor wheel based on the atmospheric pressure information.

(2) In the control device of (1), the controller may determine a settable range of the rotational speed in accordance with the atmospheric pressure.

(3) In the control device of (2), the controller may increase a lower limit value of the rotational speed in the settable range as the atmospheric pressure decreases.

(4) In the control device of (3), the controller may determine the lower limit value based on a first table, a first threshold temperature of a temperature of the phosphor wheel, and the atmospheric pressure information, the first table indicating a relationship among a plurality of atmospheric pressure conditions, the rotational speed of the phosphor wheel, and the temperature of the phosphor wheel.

(5) In the control device of (4), the first table may show a relationship in which the temperature of the phosphor wheel increases as the atmospheric pressure decreases and a relationship in which the temperature of the phosphor wheel increases as the rotational speed decreases, and the controller may select an atmospheric pressure condition corresponding to the atmospheric pressure information from among the plurality of atmospheric pressure conditions by using the first table, and may determine, as the lower limit value, a lowest rotational speed among rotational speeds at which the temperature of the phosphor wheel is less than or equal to the first threshold temperature under the selected atmospheric pressure condition.

(6) In the control device of any one of (3) to (5), the controller may set the rotational speed to the lower limit value.

(7) The control device of any one of (1) to (5) may further include a temperature sensor that acquires temperature information indicating a temperature of the phosphor wheel. The controller may control the rotational speed of the phosphor wheel based on the temperature information.

(8) In the control device of (7), the phosphor wheel may include a phosphor, a wheel body to which the phosphor is applied, and a motor that rotates the wheel body. The controller may determine an upper limit value of the rotational speed of the phosphor wheel based on a second table and a second threshold temperature of a motor temperature, the second table indicating a relationship among a plurality of atmospheric pressure conditions, the rotational speed of the phosphor wheel, and the motor temperature of the motor.

(9) In the control device of (8), the second table may show a relationship in which the motor temperature decreases as the atmospheric pressure increases and a relationship in which the motor temperature increases as the rotational speed increases, and the controller may select an atmospheric pressure condition corresponding to the atmospheric pressure information from among the plurality of atmospheric pressure conditions by using the second table, and may determine, as the upper limit value, a highest rotational speed among rotational speeds at which the motor temperature of the motor is less than or equal to the second threshold temperature under the selected atmospheric pressure condition.

(10) In the control device of any one of (7) to (9), the controller may increase the rotational speed of the phosphor wheel when the temperature of the phosphor wheel exceeds a third threshold temperature.

(11) In the control device of any one of (7) to (10), the temperature sensor may be a non-contact temperature sensor that acquires the temperature without touching the phosphor wheel.

(12) A projection display device according to the present disclosure includes any one of the control devices of (1) to (11).

The present disclosure is applicable to a control device that controls a rotational speed of a phosphor wheel, a light source device, and a projection display device.

What is claimed is:

1. A control device for controlling a rotational speed of a phosphor wheel, the device comprising:
an atmospheric pressure sensor that acquires atmospheric pressure information indicating an atmospheric pressure around the phosphor wheel; and
a controller that controls the rotational speed of the phosphor wheel based on the atmospheric pressure information.

2. The control device according to claim 1, wherein the controller determines a settable range of the rotational speed in accordance with the atmospheric pressure indicated by the atmospheric pressure information.

3. The control device according to claim 2, wherein the controller increases a lower limit value of the settable range of the rotational speed as the atmospheric pressure indicated by the atmospheric pressure information decreases.

4. The control device according to claim 3, wherein
the controller determines the lower limit value based on a first table, a first threshold temperature of the phosphor wheel, and the atmospheric pressure information, and
the first table shows a relationship among a plurality of atmospheric pressure conditions, the rotational speed of the phosphor wheel, and a temperature of the phosphor wheel.

5. The control device according to claim 4, wherein
the first table shows a relationship in which the temperature of the phosphor wheel increases as the atmospheric pressure indicated by the plurality of atmospheric pressure conditions decrease and a relationship in which the temperature of the phosphor wheel increases as the rotational speed decreases, and
the controller selects an atmospheric pressure condition corresponding to the atmospheric pressure information from among the plurality of atmospheric pressure conditions by using the first table, and determines, as the lower limit value, a lowest rotational speed among rotational speeds corresponding to temperatures less than or equal to the first threshold temperature under the selected atmospheric pressure condition.

6. The control device according to claim 3, wherein the controller sets the rotational speed to the lower limit value.

7. The control device according to claim 1, further comprising a temperature sensor that acquires temperature information indicating a temperature of the phosphor wheel,
wherein the controller controls the rotational speed of the phosphor wheel based on the atmospheric pressure information and the temperature information.

8. The control device according to claim 7, wherein
the phosphor wheel includes a phosphor, a wheel body to which the phosphor is applied, and a motor that rotates the wheel body,
the controller determines an upper limit value of a settable range of the rotational speed of the phosphor wheel based on a second table and a second threshold temperature of the motor, and
the second table shows a relationship among a plurality of atmospheric pressure conditions, the rotational speed of the phosphor wheel, and a temperature of the motor.

9. The control device according to claim 8, wherein
the second table shows a relationship in which the temperature of the motor decreases as the atmospheric pressure indicated by the plurality of atmospheric pressure conditions increase and a relationship in which the temperature of the motor increases as the rotational speed increases, and
the controller selects an atmospheric pressure condition corresponding to the atmospheric pressure information from among the plurality of atmospheric pressure conditions by using the second table, and determines, as the upper limit value, a highest rotational speed among rotational speeds corresponding to temperatures of the motor less than or equal to the second threshold temperature under the selected atmospheric pressure condition.

10. The control device according to claim 7, wherein the controller increases the rotational speed of the phosphor wheel when the temperature of the phosphor wheel exceeds a third threshold temperature.

11. The control device according to claim 7, wherein the temperature sensor is a non-contact temperature sensor that acquires the temperature without touching the phosphor wheel.

12. The control device according to claim 5, further comprising a temperature sensor that acquires temperature information indicating the temperature of the phosphor wheel,
wherein the controller increases the rotational speed of the phosphor wheel based on the first table when the temperature of the phosphor wheel exceeds the first threshold temperature.

13. The control device according to claim 12, wherein the controller sets the rotational speed of the phosphor wheel to a rotational speed corresponding to a temperature more than the first threshold temperature under the selected atmospheric pressure condition of the first table when the temperature of the phosphor wheel exceeds the first threshold temperature.

14. A projection display device comprising:
the control device according to claim 1; and
the phosphor wheel.
